(19) United States
(12) Patent Application Publication
(10) Pub. No.: US 2017/0266681 A1
(43) Pub. Date: Sep. 21, 2017

(54) MANUAL COATING GUN AND COATING STATION COMPRISING SUCH A GUN

(71) Applicant: EXEL INDUSTRIES, Epernay (FR)

(72) Inventor: Christophe PRAVERT, Grenoble (FR)

(21) Appl. No.: 15/456,813

(22) Filed: Mar. 13, 2017

(30) Foreign Application Priority Data
Mar. 21, 2016 (FR) 1652397

(51) Int. Cl. B05B 12/00; B05B 5/03; B05B 5/053; B05B 5/00

(52) U.S. Cl. CPC B05B 12/002; B05B 5/005; B05B 5/032; B05B 5/053

(57) ABSTRACT

This manual gun (2) for applying a coating product comprises a high voltage unit (42), designed for electrostatically charge the coating product at a voltage/flow rate characteristic when it is supplied with electric power, and adjustment means (16), for selecting, from among several pre-adjusted voltage/current characteristics, the voltage/current characteristic according to which the product is electrostatically charged. This gun also comprises a control member (10), which is maneuverable between an inactive configuration, where it opposes the application of the coating product and wherein the high voltage unit (42) is not supplied with electric power, and an active configuration, wherein it does not oppose the application of the coating product and wherein the high voltage unit is supplied with electric power. The adjustment means (16) comprise control buttons, giving the possibility of manually adjusting the flow rate of coating product applied by the gun when the control member (10) is in an active configuration and of selecting the voltage/current characteristic when the control member is in an inactive configuration.

The invention relates to a gun for manually applying a coating product and a station for applying a coating product comprising such a gun. In particular, the gun is a gun for manually applying electrostatic powder, designed for applying a coating product such as a paint in powder form.

In a known way, such a gun comprises a high voltage unit designed for electrostatically charging the coating product according to a certain voltage/current characteristic when it is powered with electric power. The voltage/current characteristic of the high voltage unit corresponds to the ratio between the voltage and the current issued by the high voltage unit. Therefore this is a curve representative of the time-dependent change in the voltage versus the current. Typically, the characteristic is a straight line with a negative slope. This high voltage unit is supplied with low voltage via an electric cable called a low voltage cable, which is connected to an electric module. The gun is supplied with coating product par through a pipe connected to a pump. This pump is supplied with compressed air by a control module. The flow rate of coating product pulsed by the pump depends on the pressure and on the flow rate of the compressed air with which it is supplied. The control module and the electric module are often grouped within a same electropneumatic module.

The electropneumatic module includes an interface with controls and indicators which allow the user to control different application parameters of the coating product, such as the powder flow rate, the applied high voltage or further the cleaning cycles.

In most of the guns, very few controls are available at the actual gun level. A control member is only found, currently called a trigger, which is maneuverable by the painter between an inactive rest configuration, or it opposes the application of the coating product and where the high voltage unit is not supplied with electric power, and an active operating configuration, where it does not oppose the application of the coating product and where the high voltage unit is supplied with electric power. Optionally, an indicator is found on the gun for signaling to the painter that the piece of equipment is on and/or that the trigger is in an active configuration.

Certain application stations according to the prior art give the possibility of adjusting the voltage/current characteristic of the high voltage unit in order to adapt as best to the geometry of the part. The properties of the jet vary according to the voltage/current characteristic used. In order to change the voltage/current characteristic, the painter should interrupt his/her task in order to go up to the interface located at the electropneumatic module. Now, the latter is sometimes localized relatively far from the part to be painted. This type of station is therefore not compatible with a semi-automated powdering application using a continuous conveyor and wherein painters intervene manually, for example in reworking areas. The latter cannot actually easily leave their working station.

In order to find a remedy to these drawbacks, certain high-end electrostatic guns include controls for managing the application parameters which are directly accessible from the gun. As an example, these controls give the possibility of managing the powder flow rate, of adjusting the voltage/current characteristic or further carrying out a purge request. Further, certain guns are equipped with indicators of a state return, having the function of signaling to the painter when the gun is on, when the trigger is activated or further when the gun is in a purge phase.

For example, EP-B-1 115 498 discloses a gun with manual control for applying a powder coating, which is provided with two buttons, “+” and “−” respectively, allowing adjustment of a parameter from among the powder flow rate and the high voltage. Pressing simultaneously on both buttons gives the possibility of adjusting the other parameter from among the powder flow rate and the high voltage. The manual gun comprises a control member of the On/Off type for supplying the gun with coating product. In the embodiment described, an electrode charges, during the spraying, the coating powder at a minimum high voltage. This voltage level may then be modified by simultaneously pressing on both buttons. The adjustment of the voltage/current characteristic is therefore necessarily carried out during the spraying, i.e. when the control member is in the “On” position. Thus, the fact of simultaneously pressing on the buttons does not give the possibility of modifying the voltage/current characteristic when the control member is in the “Off” position.

DE 10 2005 017 931 A1 mainly discloses two embodiments of a manual gun for applying a coating product. In the embodiment of FIG. 8, the gun comprises in the rear a hood with two control buttons which give the possibility of increasing or decreasing respectively the powdered coating product flow rate with the gun. The characteristic of the high voltage unit may be modified by simultaneously pressing on the buttons. A trigger as a button gives the possibility of controlling the spraying. The high voltage unit is not supplied with electric power when this button is released.

EP 2 055 391 A2 discloses a manual gun for applying a coating product comprising a gripping handle, a first trigger for triggering or interrupting spraying and a second trigger used for increasing or decreasing the coating product's flow rate applied by the gun. The gun also comprises push buttons, including one of which may be used for switching mode, while the other one may be used for initiating a purge phase.

WO 01/91914 A1 discloses a manual powdering gun, in which it is possible to adjust the powder's flow rate and the voltage/current characteristic required for achieving the powdering. In order to carry out these adjustments, the gun is provided with a continuous adjustment button, associated with a potentiometer for adjusting the powder's flow rate. A second adjustment button gives the possibility of selecting a voltage characteristic according to the part to be painted. Distinct adjustment means are therefore provided for adjusting the coating product's flow rate and the adjustment of the voltage/current characteristic. Another example relates to a gun marketed by the WAGNER group under reference PEMX1. This gun uses the control trigger as a means for adjusting the high voltage. When the control module of the gun detects two close actions exerted on the trigger, the voltage/current characteristic is changed. The coating product's flow rate is adjusted manually by the painter by moving backwards more or less the trigger.

However, the present guns of this type are expensive to manufacture and relatively voluminous, which makes them not very ergonomic. This stems from the electronic modules loaded onboard the gun, such as the electric conductors and the shielding components.

The goal is therefore to find a better compromise between the number of controls accessible to the painter directly on the gun, the weight of the gun, its volume and its cost. For this purpose, the invention relates to a manual gun for applying a coating product, this gun comprising a high voltage unit, designed for electrostatically charge the coating product according to a voltage/current characteristic when it is supplied with electric power, as well as adjustment means, for selecting, from among several pre-adjusted characteristics of voltage/current, the voltage/current characteristic according to which the product is electrostatically charged. This gun also comprises a control member, which is maneuverable between an inactive configuration, where it opposes the application of the coating product and wherein the high voltage unit is not supplied with electric power, and an active configuration, wherein it does not oppose the application of the coating product and wherein the high voltage unit is supplied with electric power. According to the invention, the adjustment means comprise control buttons, giving the possibility of manually adjusting the coating product's flow rate applied by the gun when the control member is in an active configuration and of selecting the voltage/current characteristic of the high voltage unit when the control member is in an inactive configuration.

By means of the invention, the electronic circuits used for managing the switching of voltage/current characteristic and the changing of coating product's flow rate are relatively simple since the control buttons act both on the coating product's flow rate when the control member is in an active configuration and on the voltage/current characteristic when the control member is in an inactive configuration. In other words, the same wiring is used for adjusting the high voltage and for adjusting the applied coating product's flow rate. This type of wiring is not known to the guns of the prior art, on which are most often provided independent electronic control circuits.

According to advantageous aspects but non-mandatory of the invention, the gun may comprise one or several of the following features, taken in any technically acceptable combination:

The control buttons include a first button, for increasing the coating product's flow rate when the member is in an active configuration and for changing the voltage/current characteristic when the member is in an inactive configuration, and a second button, for decreasing the coating product's flow rate when the member is in an active configuration and changing the voltage/current characteristic when the member is in an inactive configuration.

The first button is coated with the sign “+”, while the second button is coated with the sign “−”.

The gun comprises at least one first indicator light for signaling the selected voltage/current characteristic.

The first indicator light is a light-emitting diode, the color of which varies according to the selected voltage/current characteristic.

The first indicator light is a blinking light-emitting diode, the blinking frequency of which varies depending on the selected voltage/current characteristic.

The first indicator light remains lit, regardless of the configuration of the control member.

The gun comprises a second indicator light for signaling a change in the coating product's flow rate.

The gun comprises a third indicator light for signaling when the maximum or minimum flow rate of the coating product is attained.

The first indicator light and the second indicator light are each a bar graph, configured for permanently displaying the selected voltage/current characteristic or the coating product's flow rate.

The first indicator light and the second indicator light are a same bar graph, configured for displaying the selected voltage/current characteristic when the control member is in an inactive configuration or the coating product's flow rate when the control member is in an active configuration.

The control buttons give the possibility of exclusively acting on the coating product's flow rate applied by the gun when the control member is in an active configuration and of exclusively acting on the voltage/current characteristic of the high voltage unit when the control member is in an inactive configuration.

The invention also relates to a station for applying a coating product, comprising a manual application gun as described earlier, a pump for supplying the gun with a coating product, a control module for controlling the pump and an electric module for supplying the gun with electric power.

The invention finally relates to a method for applying a coating product with a manual gun as defined earlier, this method comprising successive steps consisting of:
a) taking hold of the gun,
b) by acting on the control buttons, selecting a voltage/current characteristic of the high voltage unit,
c) maneuvering the control member of the inactive configuration towards the active configuration, and
d) by acting on the control buttons, adjusting the flow rate of the coating product applied by the gun.

The invention and other advantages thereof will become more clearly apparent in the light of the description which follows of three embodiments of a gun in accordance with its principle, only given as an example and made with reference to the appended drawings wherein:

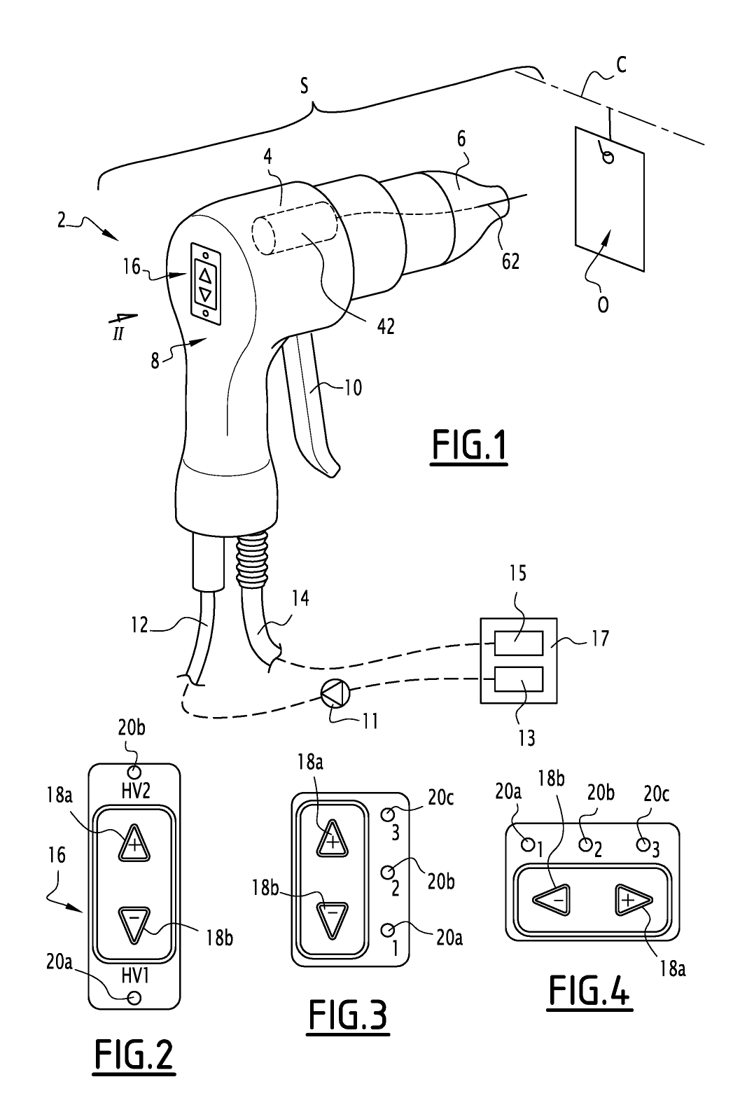

FIG. 1 is a perspective view of a manual gun for applying a coating product according to a first embodiment of the invention,

FIG. 2 is a view at a larger scale along the arrow II in FIG. 1, and

FIGS. 3 and 4 are similar views to FIG. 2 respectively illustrating control buttons belonging to a gun according to a second and third embodiment of the invention.

In FIGS. 1 and 2, a first embodiment of a manual gun 2 for applying a coating product is illustrated. In the example, the coating product is a paint in powder form.

The gun 2 belongs to an application station S which includes a pump 11 for supplying the gun with a coating product, a control module 13 for controlling the pump, and an electric module 15 for supplying the gun 2 with electric power. The electric module and the control module are grouped within a same electropneumatic module 17. A pipe 12 connects the gun 2 to the pump 11. A low voltage cable 14 connects the gun 2 to the electric module 13.

The gun 2 comprises a body 4 and a nozzle 6 for ejecting the coating product towards an object O to be coated displaced by a conveyor C. Advantageously, the nozzle 6 is mounted removably on the body 4. The gun 2 may operate both with a nozzle with a flat jet and with a nozzle with a round jet.

A high voltage unit 42 is positioned in the body 4 and designed for electrostatically charging the coating product according to a pre-adjusted voltage/current characteristic when it is supplied with electric power via the cable 14. Advantageously, the high voltage unit comprises an electrode 62 positioned at the center of the nozzle 6.

The gun 2 also comprises a control member 10 which, in the example is a movable trigger relatively to the body 4. The control member 10 is maneuverable by the painter between an inactive rest configuration, where it opposes the application of the coating product by the gun 2 and wherein the high voltage unit is not supplied with electric power, and an active operating configuration, wherein it does not oppose the application of the coating product and wherein the high voltage unit is supplied with electric power. The member 10 therefore forms a control means for applying the coating product and for charging the coating product to a high voltage. Typically, the control member 10 may be actuated by the user by positioning the palm of his/her hand against a rear face 8 of the body 4 of the gun 2 and by pulling the control trigger 10 with his/her fingers. Alternatively, the control trigger may be provided as a push button, the user then pressing on the button with his/her index finger.

In the example, the control member 10 acts for cutting off the supply of coating product and on an electric contactor, or a switch, not shown, for selectively cutting off the supply of the high voltage unit with electrical power.

Return means not visible in the figures give the possibility of returning the control member 10 to the inactive configuration.

A user interface 16 is positioned on a rear face 8 of the body 4 of the gun 2 corresponding to the face of the body 4 opposite to the ejection nozzle 6 of the coating product. The fact that the user interface 16 is positioned on the rear face 8 of the body 4 makes its handling easy by a user.

The interface 16 comprises two control buttons, 18a and 18b respectively, giving the possibility of manually adjusting the coating product's flow rate when the control member 10 is in an active configuration and of manually selecting the voltage/current characteristic when the member 10 is in an inactive configuration. The control buttons 18a and 18b therefore form adjustment means, in order to select, from among several high voltage levels, the voltage/current characteristic according to which the product is charged electrostatically and also means for adjusting the coating product's flow rate.

In particular, both control buttons 18a and 18b give the possibility of exclusively acting on the coating product's flow rate when the control member 10 is in an active configuration and of exclusively acting on the voltage/current characteristic when the member 10 is in an inactive configuration. Thus, and unlike the embodiment of the gun described in DE 10 2005 017 931 A1 for example, in the invention, when the control member 10 is in an active configuration, the user cannot modify the voltage/current characteristic and when the control member 10 is in an inactive configuration, the user cannot adjust the spraying flow rate.

The properties of the jet vary according to the used voltage/current characteristic. For example, a voltage/current characteristic with a low slope is further adapted for a nozzle with a flat jet, while a voltage/current characteristic with a higher slope is as for it rather adapted for a nozzle with a round jet. Also, the voltage/current characteristic is also adapted according to the complexity of the part to be coated.

The first button 18a gives the possibility of increasing the coating product's flow rate when the member 10 is in an active configuration and gives the possibility of changing the voltage/current characteristic when the member 10 is in an inactive configuration. The second button 18b gives the possibility of decreasing the coating product's flow rate when the member is in an inactive configuration and of changing the voltage/current characteristic when the member is in an inactive configuration.

In particular, the first button 18a gives the possibility of selecting a voltage/current characteristic with a lower slope when the member 10 is in an inactive configuration, while the second button 18b gives the possibility of selecting a voltage/current characteristic with a larger slope when the member 10 is in an inactive configuration.

The first button 18a is coated with the sign “+”, while the second button 18b is coated with the sign “−”, which makes their use intuitive. When the gun 2 is held vertically, the button 18b is laid out above the button 18a.

The control interface 16 also comprises two indicator lights, 20a and 20b respectively, for signaling the voltage/current characteristic which is selected from among the different pre-adjusted voltage/current characteristics. In the example of FIGS. 1 and 2, two high voltage levels, HV1 and HV2 respectively, each corresponding to a certain voltage/current characteristic are available. Both of these characteristics are pre-adjusted on the electric module 15. Thus, the activation of the buttons 18a and 18b when the member 10 is in an inactive configuration gives the possibility of selecting the voltage/current characteristic applied by the unit 42 to the electrode 6, from among the corresponding characteristics to the high voltage levels HV1 and HV2. When, the voltage/current characteristic corresponding to the high voltage HV1 is used, the indicator light 20a is lit, while when the voltage/current characteristic corresponding to the high voltage HV2 is used, the indicator light 20b is lit. The indicator lights 20a and 20b are light-emitting diodes.

Advantageously, the indicator light 20a or 20b remains lit regardless of the configuration of the control member 10.

Optionally, the electropneumatic module also comprises a control interface.

In FIG. 3, is illustrated a user interface belonging to a second embodiment of a gun according to the invention. In FIG. 4 is illustrated a user interface belonging to a third embodiment of a gun according to the invention. In the following, only the differences relatively to the first embodiment are described for the sake of conciseness. Further, the elements identical with those of the first embodiment retain their numerical reference, while the other elements bear other numerical references.

In the embodiment of FIG. 3, the user may select a voltage/current characteristic from among three available characteristics. The user interface 16 of FIG. 3 then comprises three indicator lights, 20a, 20b and 20c, respectively, for signaling the selected voltage/current characteristic.

Unlike the first two embodiments, in the embodiment of FIG. 4, the user interface 16 is positioned horizontally. Thus, when the gun 2 is held upright, the button 18b is laid out on the left of the button 18a.

In order to proceed with the application of the coating product, the user begins, during a step a), by grasping the gun, and then, during a step b), he/she selects a voltage/current characteristic of the high voltage unit 42 by acting on the control buttons 18a and 18b. Next, the user maneuvers, during a step c), the control member 10 from the inactive configuration to the active configuration, and thus begins spraying. Finally, by acting on the control buttons 18a and 18b, the user adjusts, during a step d), the coating product's flow rate applied by the gun 2.

Advantageously, and given that the gun 2 comprises means for returning the control member 10 into an inactive configuration, when the control member 10 is returned in an inactive configuration, a new voltage/current characteristic may be selected by acting on the control buttons 18a and 18b.

In an alternative not shown, the number of voltage/current characteristics which may be selected by the painter is greater than 3.

In an alternative not shown, the gun comprises a single indicator light for signaling to the painter the selected voltage/current characteristic from among the different pre-adjusted characteristics. Advantageously, this indicator light is a light-emitting diode, for which the color varies depending on the selected voltage/current characteristic. Alternatively, the indicator light is a blinking light-emitting diode, the blinking frequency of which varies according to the selected voltage/current characteristic.

According to another embodiment not shown, the gun 2 comprises another indicator light for signaling a change in the flow rate of the coating product. Advantageously, the gun further comprises another indicator light for signaling when the maximum flow rate or the minimum flow rate of the coating product is attained. This indicator light may be of the type described earlier and may be the same indicator light as the one used for signaling a change in flow rate of the coating product.

According to another alternative not shown, the user interface comprises a bar graph representative of the selected voltage/current characteristic and/or a bar graph representative of the coating product's flow rate. Each bar graph is configured for permanently displaying the selected voltage/current characteristic or the coating product's flow rate.

Advantageously, the same bar graph may be used for alternatively indicating the selected voltage/current characteristic and the coating product's flow rate. In the example, this bar graph is configured for displaying the selected voltage/current characteristic when the control member is in an inactive configuration or the coating product's flow rate when the control member is in an active configuration.

For example, the bar graph may be configured for changing color according to the position of the control member 10 in order to indicate to the operator on whether this is the high voltage or the flow rate by pressing on the buttons 18a and 18b.

The characteristics of the alternatives and embodiments contemplated above may be combined together in order to generate new embodiments of the invention.

1. A manual gun for applying a coating product, this manual gun comprising:
a high voltage unit, designed for electrostatically charging the coating product according to a pre-adjusted voltage/current characteristic when the high voltage unit is supplied with electric power,
adjustment means, for selecting from among several pre-adjusted voltage/current characteristics, the voltage/current characteristic according to which the coating product is charged electrostatically,
a control member, which is maneuverable between an inactive configuration, wherein the control member opposes the application of the coating product and wherein the high voltage unit is not supplied with electric power, and an active configuration, wherein the control member does not oppose the application of the coating product and wherein the high voltage unit is supplied with electric power,
wherein the adjustment means comprise control buttons, giving the possibility of manually adjusting a coating product flow rate applied by the manual gun when the control member is in an active configuration and of selecting the voltage/current characteristic of the high voltage unit when the control member is in an inactive configuration.

2. The manual gun according to claim 1, wherein the control buttons include:
a first button increasing the coating product flow rate when the control member is in an active configuration and for changing the voltage/current characteristic when the control member is in an inactive configuration, and
a second button for decreasing the coating product flow rate when the control member is in an active configuration and changing the voltage/current characteristic when the control member is in an inactive configuration.

3. The manual gun according to claim 2, wherein the first button is coated with the sign “+”, while the second button is coated with the sign “−”.

4. The manual gun according to claim 1, comprising at least one first indicator light for signaling the selected voltage/current characteristic.

5. The manual gun according to claim 4, wherein the first indicator light is a light-emitting diode, the color of which varies according to the selected voltage/current characteristic.

6. The manual gun according to claim 4, wherein the first indicator light is a blinking light-emitting diode, the blinking frequency of which varies according to the selected voltage/current characteristic.

7. The manual gun according to claim 4, wherein the first indicator light remains lit, regardless of the configuration of the control member.

8. The manual gun according to claim 1, comprising a second indicator light for signaling a change in the flow rate of coating product.

9. The manual gun according to claim 1, comprising a third indicator light for signaling whether maximum or minimum flow rate of coating product is attained.

10. The manual gun according to claim 8, comprising at least one first indicator light for signaling the selected voltage/current characteristic, wherein the first indicator light and the second indicator light are each a bar graph, configured for permanently displaying the selected voltage/current characteristic or the coating product flow rate.

11. The manual gun according to claim 8, comprising at least one first indicator light for signaling the selected voltage/current characteristic, wherein the first indicator light and the second indicator light are a same bar graph, configured for displaying the selected voltage/current characteristic when the control member is in an inactive configuration or the coating product flow rate when the control member is in an active configuration.

12. The manual gun according to claim 1, wherein the control buttons give the possibility of exclusively acting on the coating product flow rate applied by the manual gun when the control member is in an active configuration and of exclusively acting on the voltage/current characteristic of the high voltage unit when the control member is in an inactive configuration.

13. A station for applying a coating product, comprising:
a manual gun,
a pump for supplying the manual gun with the coating product,
a control module for controlling the pump, and
an electric module for supplying the manual gun with electric power,
wherein the manual gun is according to claim 1.

14. A method for applying a coating product with a manual gun as defined in claim 1, this method comprising successive steps consisting of:
a) taking hold of the manual gun,
b) by acting on the control buttons, selecting a voltage/current characteristic of the high voltage unit,
c) maneuvering the control member from the inactive configuration to the active configuration, and
d) by acting on the control buttons, adjusting the coating product flow rate applied by the manual gun.
